(19) United States
(12) Patent Application Publication
(10) Pub. No.: US 2005/0139532 A1
(43) Pub. Date: Jun. 30, 2005

(54) Manifold assembly

(76) Inventors: David Hershberger, Kalamazoo, MI (US); Stephen P. Isham, Kalamazoo, MI (US); Bruce MacDonald, Portage, MI (US); Karen L. Staley, Kalamazoo, MI (US); Brian Adloff, Baltimore, MD (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/969,619

(22) Filed: Oct. 20, 2004

Related U.S. Application Data
(60) Provisional application No. 60/512,671, filed on Oct. 20, 2003.

(51) Int. Cl. B01D 35/30

(52) U.S. Cl. 210/136; 137/602; 137/605; 210/95; 210/435; 210/335

(57) ABSTRACT

A manifold assembly (100) for directing and filtering material (102) from fluid flowing into a medical waste collection device (104) includes a plurality of inlet ports (116) and an outlet port (118) with a filter (108, 110, 112) disposed between the ports (116, 118) along a fluid path (120). An outlet check-valve (114) is disposed at the outlet port (118) for opening in response to a predetermined vacuum pressure applied to the outlet port (118) from the medical waste collection device (104).

### RELATED APPLICATION

This application claims the benefit of U.S. Provisional Patent Application Ser. No. 60/512,671, which was filed on Oct. 20, 2003.

### BACKGROUND OF THE INVENTION

1. Field of the Invention

This invention is directed to a filter system and, more particularly, to a filter system for removing solids or semi-solids from a fluid or liquid carrier.

2. Description of the Prior Art

There are many uses for filter systems and/or devices for removing certain types of materials from a carrier, such as fluid. One such application is the removal of solid or semi-solid material, such as bone chips, flesh, blood clots or the like, from a fluid carrier generated during some types of medical procedures or surgeries by using a filtration process. This filtration process permits the fluid carrier to be treated separately from the material that is trapped by the filtration process.

One such example of this type of filtration process is disclosed in U.S. Pat. No. 6,331,246 to Beckham et al. (the '246 patent). The '246 patent discloses a manifold assembly for use with a medical waste collection device for filtering a fluid carrier, generated during a medical process, that may contain material within the fluid carrier. The manifold assembly includes a manifold housing, inlet ports, an outlet port, and a series of filters disposed between the inlet and outlet ports. The filters eliminate the material from the fluid carrier passing therethrough. Duck-bill valves are placed only on the inlet ports to establish unidirectional flow and to prevent reverse flow of the fluid carrier therethrough. However, when the manifold assembly is removed from the medical waste collection device, the residual fluid that may linger in the manifold assembly is not prevented from dripping from the outlet port.

### SUMMARY OF THE INVENTION AND ADVANTAGES

This invention provides a manifold assembly for directing and filtering material from fluid flowing into a medical waste collection device. The assembly comprises a manifold housing defining a plurality of inlet ports and an outlet port in spaced relationship to the inlet ports to establish a fluid path. A primary filter is disposed in the fluid path between the inlet ports and the outlet port to filter the material from the fluid in the fluid path. An outlet check-valve is disposed at the outlet port for opening in response to a predetermined vacuum pressure applied to the outlet port from the medical waste collection device.

By incorporating an outlet check-valve on the outlet port, when vacuum pressure is not applied to the outlet port, the outlet-check valve will remain drip-free. Therefore, when the manifold assembly is removed from the medical waste collection device, any fluid remaining in the manifold assembly will not drip. This results in a more sterile manifold assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of a medical waste collection device with a manifold assembly inserted therein;

FIG. 2 is an a perspective view of a first embodiment of the manifold assembly for the medical waste collection device;

FIG. 3 is an exploded perspective view of the embodiment of FIG. 2;

FIG. 4 is a cross-sectional side view of the first embodiment of FIG. 2;

FIG. 5 is a perspective view from the top, partially broken away and in cross-section of the embodiment shown in FIG. 2;

FIG. 6 is another perspective view from the bottom, partially broken away and in cross-section of the embodiment shown in FIG. 2;

FIG. 7 is a fragmentary cross-sectional view of the inlet port of the embodiment of FIG. 2;

FIG. 8 is a fragmentary cross-sectional view of the outlet port of the embodiment of FIG. 2;

FIG. 9 is a fragmentary cross-sectional view of the interface between a manifold body and a manifold lid of the embodiment of FIG. 2;

FIG. 10 is a cross-sectional side view of a check-valve in a relaxed state;

FIG. 11 is a perspective view of the top of a check-valve in a relaxed state;

FIG. 12 is a cross-sectional side view of a fully extended check-valve with the valve closed;

FIG. 13 is a cross-sectional side view of a fully extended check-valve with the valve partially open;

FIG. 14 is a cross-sectional side view of a fully extended check-valve with the valve fully open;

FIG. 15 is a top view of a fully extended check-valve with the valve fully open;

FIG. 16 is a perspective view of a second embodiment of the manifold assembly for the medical waste collection device;

FIG. 17 is an exploded perspective view of the second embodiment of FIG. 16;

FIG. 18 is a perspective view, partially broken away and in cross-section, of the top and side of the second embodiment of FIG. 16;

FIG. 19 is a perspective view of a third embodiment of the manifold assembly for the medical waste collection device showing an access cover closing an access port on the manifold top;

FIG. 20 is an exploded perspective view of the third embodiment of FIG. 19 showing the access cover removed from the access port on the manifold top;

FIG. 21 is a perspective view, partially broken away and in cross-section, of the top and side of the third embodiment of FIG. 19;

FIG. 22 is a perspective view of a fourth embodiment of the manifold assembly for the medical waste collection device;

FIG. 23 is an exploded perspective view of the fourth embodiment of FIG. 22; and

FIG. 24 is a perspective view, partially broken away and in cross-section, of the top and side of the fourth embodiment of FIG. 22.

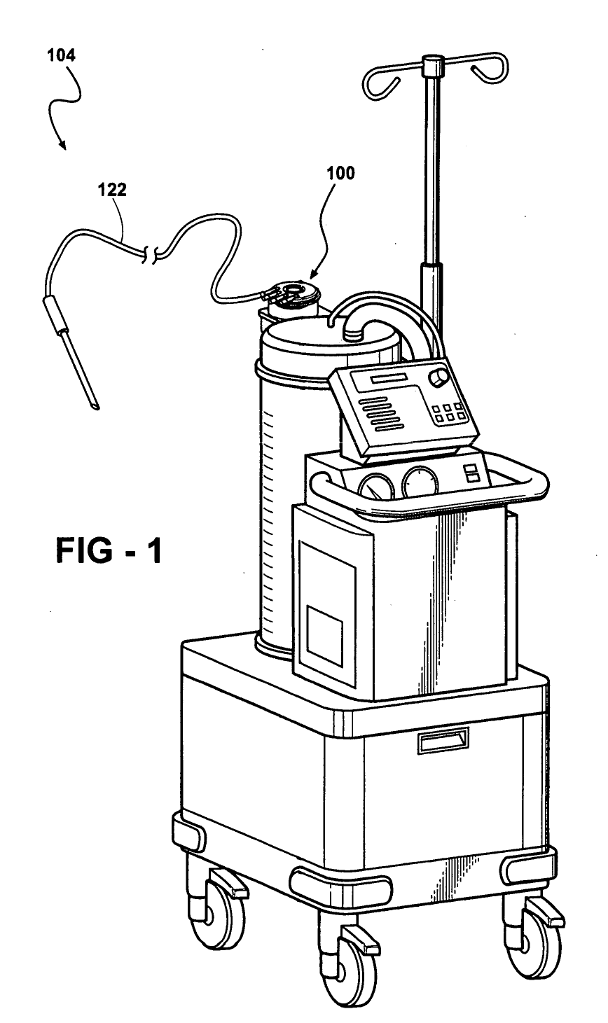

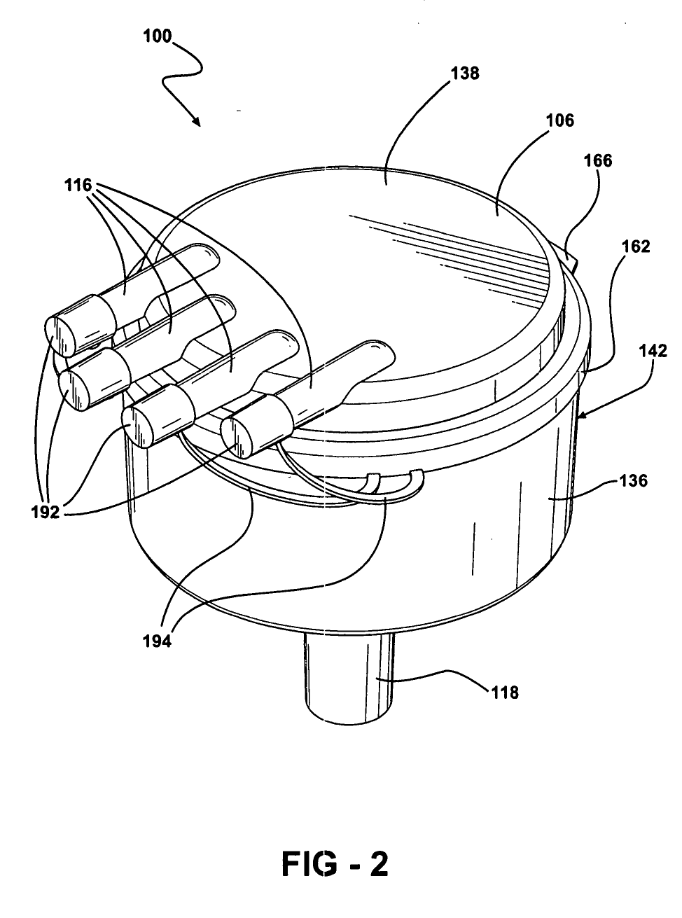

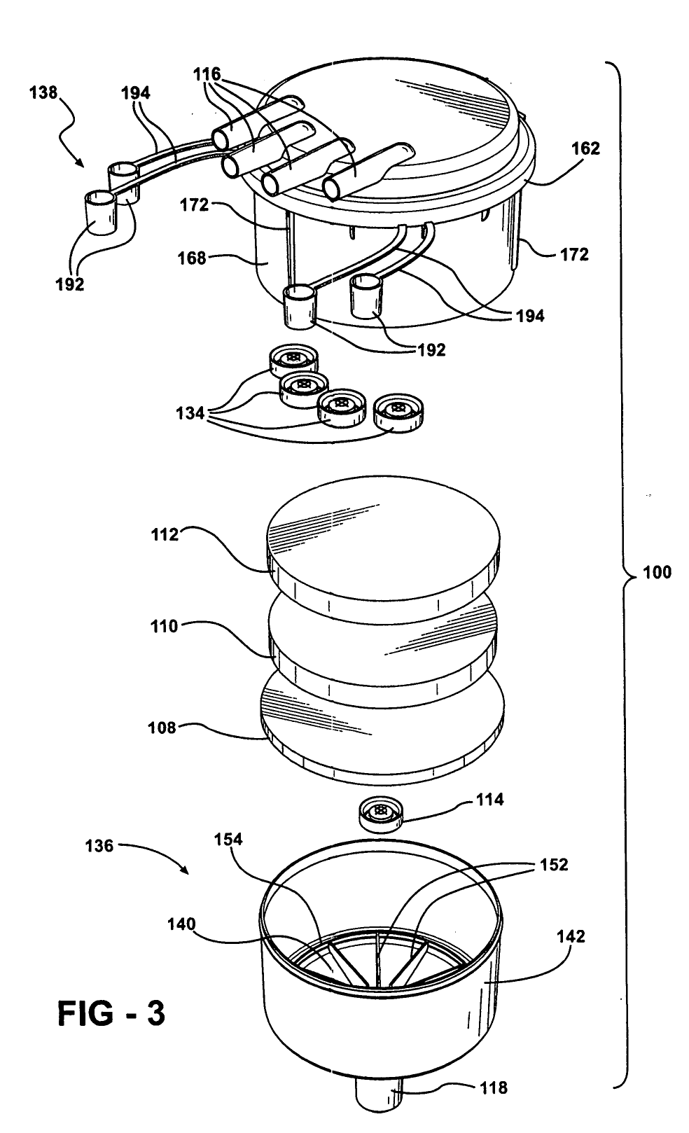

### DETAILED DESCRIPTION OF THE PREFERRED EMBODIMENT

Referring to the Figures, wherein like numerals indicate like or corresponding parts throughout the several views, a manifold assembly 100 for directing and filtering material 102 from fluid flowing into a medical waste collection device is shown generally at 104.

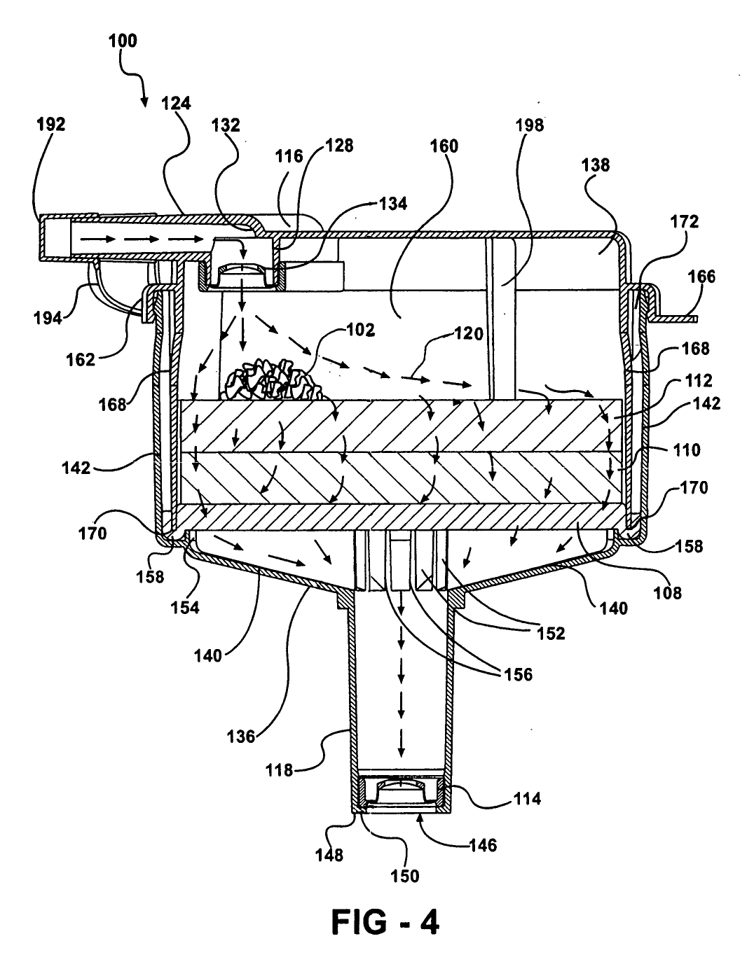

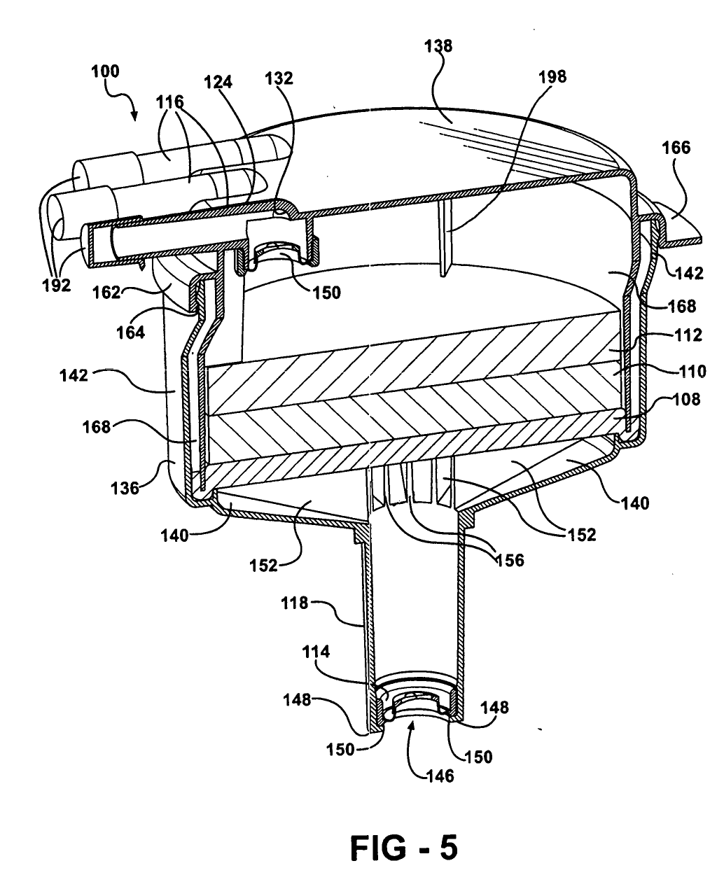

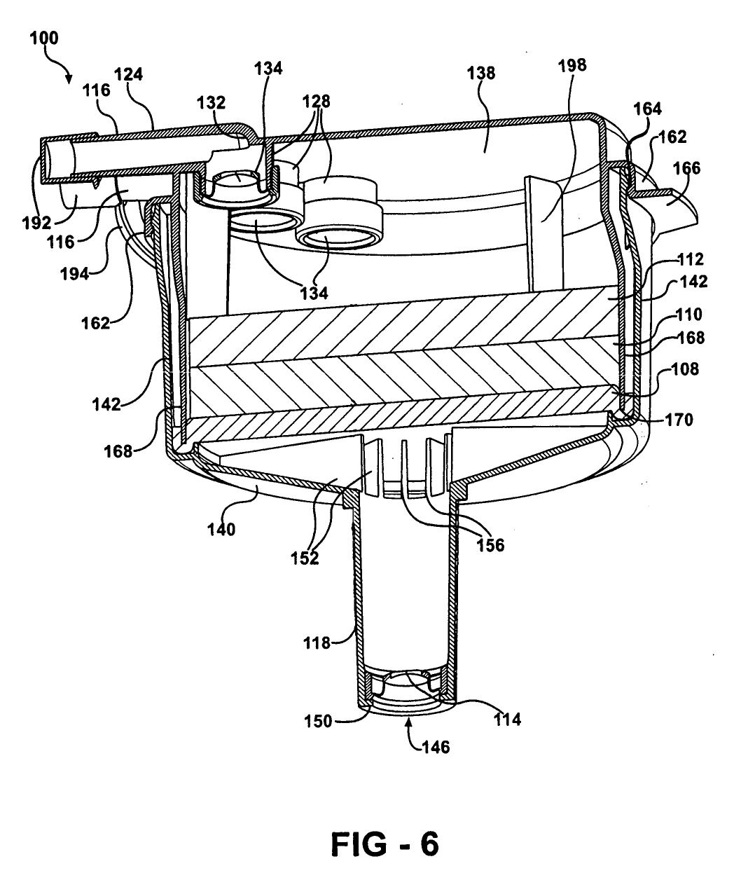

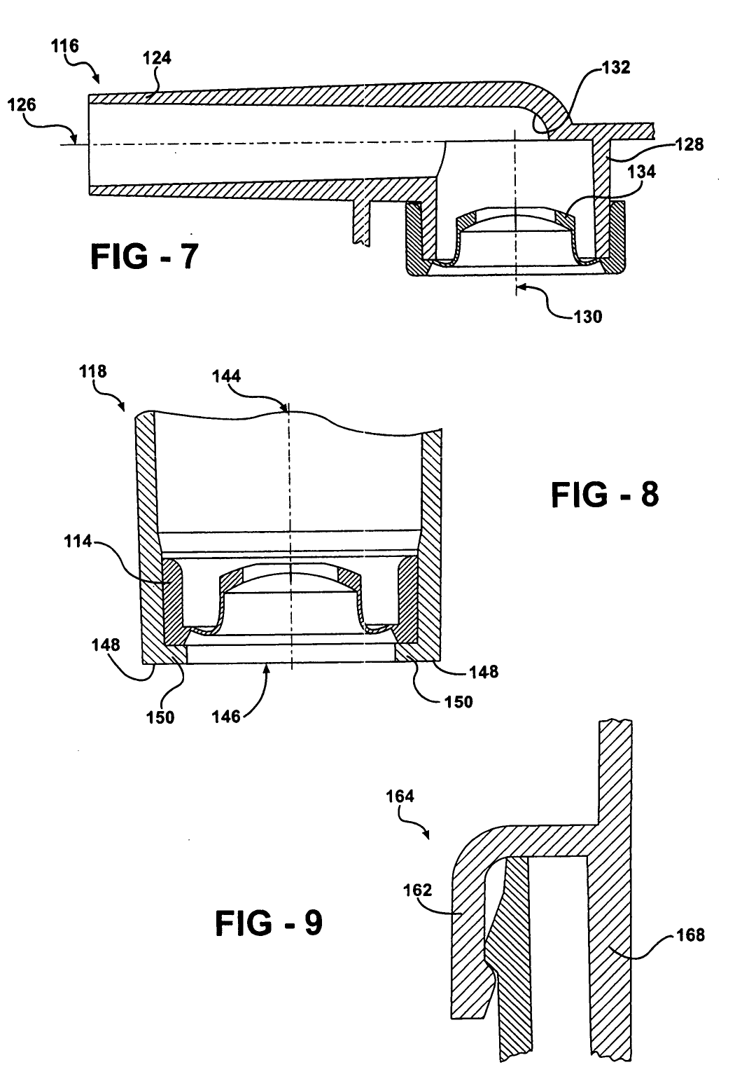

The manifold assembly 100 comprises a manifold housing 106, a primary filter 108, and an outlet check-valve 114. However, it is typical that there is a plurality of filter layers 108, 110, 112. The manifold housing 106 defines a plurality of inlet ports 116 and an outlet port 118 in spaced relationship to the inlet ports 116 to establish a fluid path 120, as illustrated in FIG. 4. Typically, inlet hoses 122 are connected to the inlet ports 116 during a surgical procedure to transport the waste from the patient to the manifold assembly 100 during the surgical procedure through the inlet ports 116. After the fluid passes through the inlet ports 116, it passes through the filters 108, 110, 112, along the fluid path 120, and out through the outlet port 118 where it enters the medical waste collection device 104. It is common that when the fluid initially enters the manifold assembly 100 through the inlet ports 116, material 102 from the patient, such as bone chips, blood clots, or the like are suspended in the fluid. As the fluid passes through the filters 108, 110, 112, the material 102 is filtered out and left on the surfaces of the filters 108, 110, 112, as illustrated in FIG. 4. Preferably, each of the filters 108, 110, 112 has a different porosity where the filtration parameters of the filters 108, 110, 112 can have a range of 5 to 30 pores per linear inch. However, the filters 108, 110, 112 can have any combination of porosity. The filters 108, 110, 112 are shaped as flat discs and are sandwiched. Use of filters 108, 110, 112 that are flat discs allows for a reduction in the residual fluid volume which facilitates material 102 collection. Additionally, each filter 108, 110, 112 can have a different thickness which increases the overall volume of filter material. By increasing the volume of the filters 108, 110, 112, the time before the filters 108, 110, 112 will clog, as material 102 becomes suspended in the filters 108, 110, 112, is increased.

Each of the inlet ports 116 includes an entrance tube 124 disposed about an entry axis 126. The entry axes 126 can be parallel or non-parallel. Each of the inlet ports 116 also include an exit tube 128, disposed on an exit axis 130, transverse to the entry axis 126. Each of the entrance tubes 124 include a directional wall 132, normal to the entry axis 126, for turning the fluid entering from the entry axis 126 into the inlet exit tube 128, along the exit axis 130. An inlet check-valve 134 is disposed at each of the inlet ports 116 for opening in response to a predetermined vacuum pressure applied to the outlet port 118 from the medical waste collection device 104. Additionally, each of the inlet check-valves 134 is disposed about one of the exit tubes 128.

The manifold housing 106 includes a manifold body 136 and a manifold top 138 and the inlet ports 116 can be disposed on either the manifold body 136 or the manifold top 138. The integration of the inlet ports 116 within the manifold top 138 improves manufacturability by reducing the number of parts in the total manifold assembly 100.

The manifold body 136 is substantially rigid and includes a bottom 140 and a peripheral wall 142 extending upwardly from the bottom 140. The outlet port 118 is disposed in the bottom 140 of the manifold body 136 and extends downwardly therefrom about an outlet axis 144 to an outlet end 146. The outlet port 118 is centrally disposed and the bottom 140 is conical and slopes downwardly from the peripheral wall 142 to the outlet port 118. The outlet port 118 extends to a lower end 148 and a retaining flange 150 extends radially inward at the outlet end 146 where the outlet check-valve 114 is disposed on the retaining flange 150 within the outlet port 118 on the outlet axis 144.

The manifold body 136 further includes a plurality of spaced support spokes 152 extending radially from the outlet port 118 and the primary filter 108 is supported by the support spokes 152. The manifold body 136 further includes an outer rim 154 disposed adjacent the peripheral wall 142 and about, and engaging, the support spokes 152. Each of the support spokes 152 have inner edges 156 parallel with the outlet port 118 with the inner edges 156 surrounding the outlet port 118. The outer rim 154 is spaced from the peripheral wall 142 to define a groove 158 therebetween.

The manifold top 138 is also substantially rigid and is disposed over the peripheral wall 142 to define a chamber 160. The manifold top 138 includes a peripheral brim 162 that extends over and engages the exterior of the peripheral wall 142. A snap together lock 164 interconnects the peripheral brim 162 and the peripheral wall 142 to removably connect and retain the manifold top 138 on the manifold housing 106. Additionally, a tab 166 extends laterally away from the peripheral brim 162 to provide a gripping surface for removal of the manifold top 138.

The manifold top 138 includes a skirt 168 defining a cylinder, extending downwardly to a bottom edge 170. The cylinder, which is disposed between the outer rim 154 and the peripheral wall 142 for engaging the primary filter 108 about the outer rim 154 and the bottom edge 170 of the skirt 168, is received in the groove 158. The primary filter 108 has a diameter that is slightly larger than the other filters 110, 112. Thus, the bottom edge 170 of the skirt 168 engages a perimeter of the primary filter 108 to compress the perimeter into the groove 158.

To assist with the insertion of the skirt 168 of the manifold top 138 inside of the peripheral wall 142 of the manifold body 136, a plurality of alignment ribs 172 are disposed on the skirt 168. These alignment ribs 172 engage the peripheral wall 142 of the manifold housing 106 to center the manifold top 138 with the manifold body 136. Additionally, a plurality of retainers 198 are disposed on and spaced about the skirt 168 in the chamber 160 where the filters 108, 110, 112 are disposed above the support spokes 152 and disposed below the retainers 198 for retaining the filters 108, 110, 112 on the support spokes 152.

The filters 108, 110, 112 are disposed in the fluid path 120 between the inlet ports 116 and the outlet port 118 to filter the material 102 from the fluid in the fluid path 120. The outlet check-valve 114 is disposed at the outlet port 118. When an external vacuum is applied to the outlet port 118, from the medical waste collection device 104, at a predetermined vacuum pressure, the resulting pressure differential across the outlet port 118 causes the outlet check-valve 114 to open. The outlet check-valve 114 is drip-free which means that when vacuum is not applied to the outlet port 118, the outlet check-valve 114 remains closed and residual fluid does not leak. It is preferable that these valves are check-valves 114, 134 as check-valves 114, 134 have a higher closing force than the duck bill valves that have been used in the prior art. However, a mechanical valve is also acceptable. Additionally, the check-valves 114, 134 are preferably made of silicone rubber, although other materials 102 that yield a drip-free valve would also be acceptable.

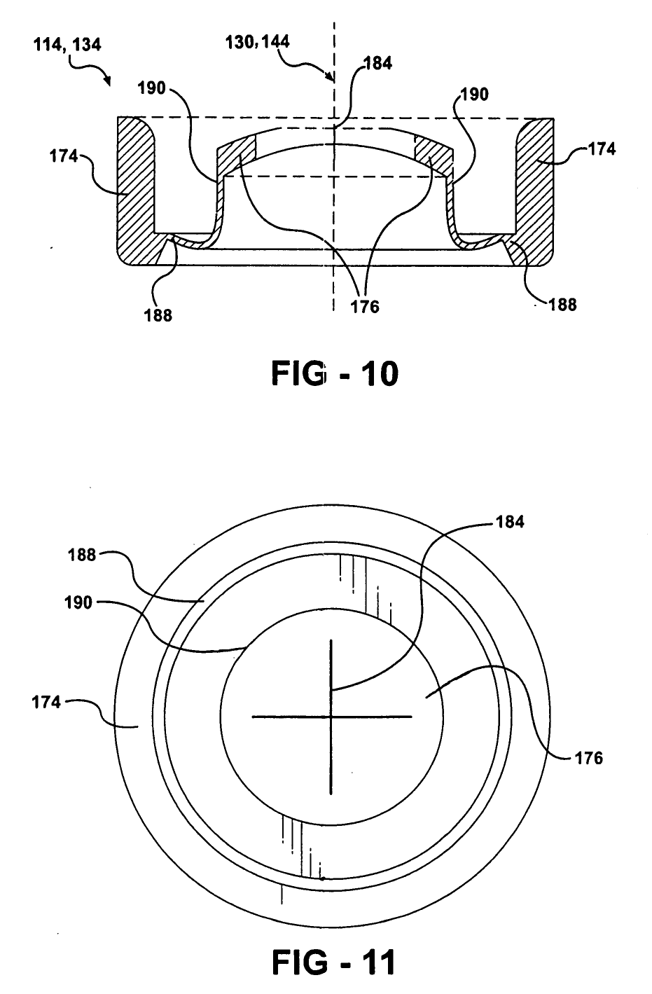

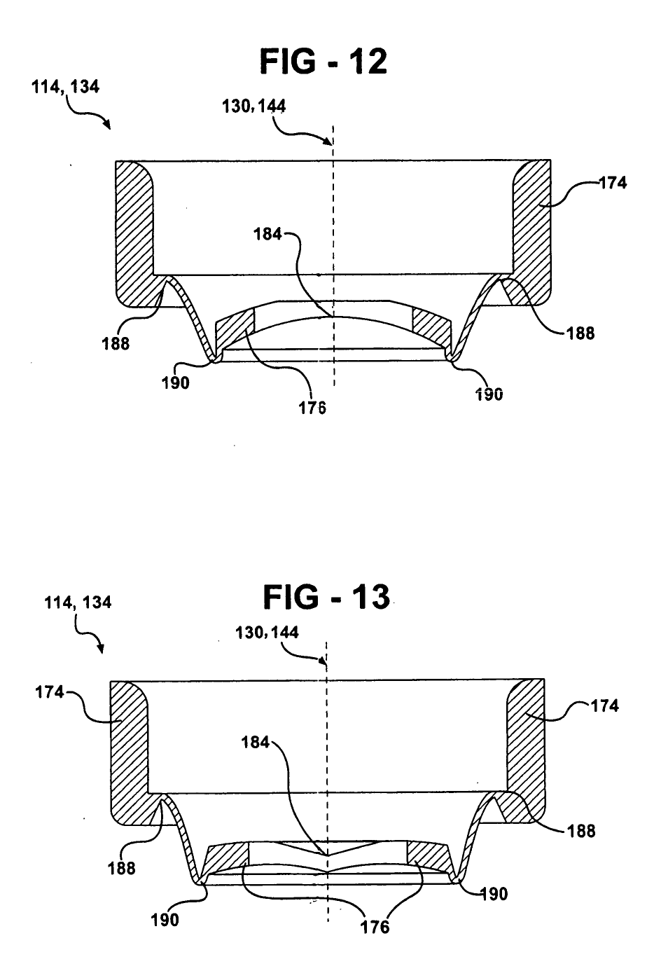

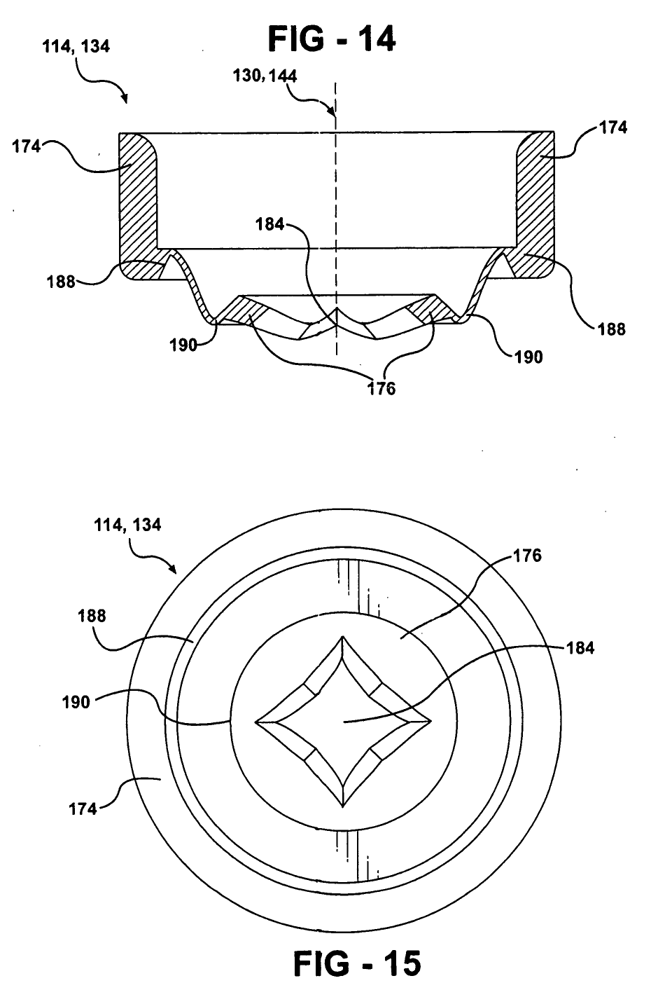

An example of an acceptable check-valve 114,134 is shown in FIGS. 10-15. The check-valve 114, 134 has a marginal flange portion 174 that is shaped to seal off openings of the ports 116, 118. Additionally, the check-valve 114, 134 has a valve head portion 176 with an orifice 184 which opens to permit fluid flow therethrough in response to a predetermined vacuum pressure differential applied across the outlet port 118. The valve head portion 176 is shaped for shifting generally centrally with respect to the marginal flange portion 174. A connector sleeve portion 186, which has a resiliently flexible construction, has a first end area 188 connected with the marginal flange portion 174 and a second end area 190 connected with the valve head portion 176. Finally, the connector sleeve portion 186 has a configuration which applies an outwardly directed torque to the valve head portion 176 when the pressure differential across the valve head portion 176 is above the predetermined discharge pressure differential to assist in opening the orifice 184.

Optionally, there are a plurality of port caps 192, for covering the plurality of inlet ports 116. The port caps 192 can be used to selectively cover each of the respective inlet ports 116. The port caps 192 can be used to cap off the inlet ports 116 prior to removing the manifold assembly 100 from the medical waste collection device 104 thereby containing the manifold assembly 100 contents after use in the absence of inlet check-valves 134. Also, a plurality of connection straps 194 can be used for retaining each of the port caps 192 to the manifold housing 106 when each port cap 192 is not covering the associated inlet port 116. The connection straps 194 are integrally formed on the manifold housing 106 and connect each of the port caps 192 to the manifold housing 106. Alternatively, the connection straps 194 can be completely removable from the manifold housing 106.

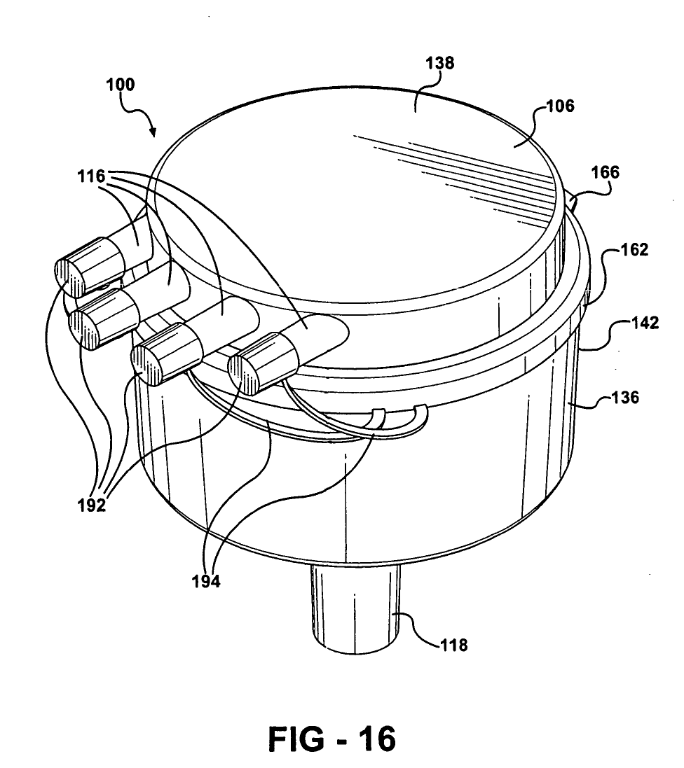

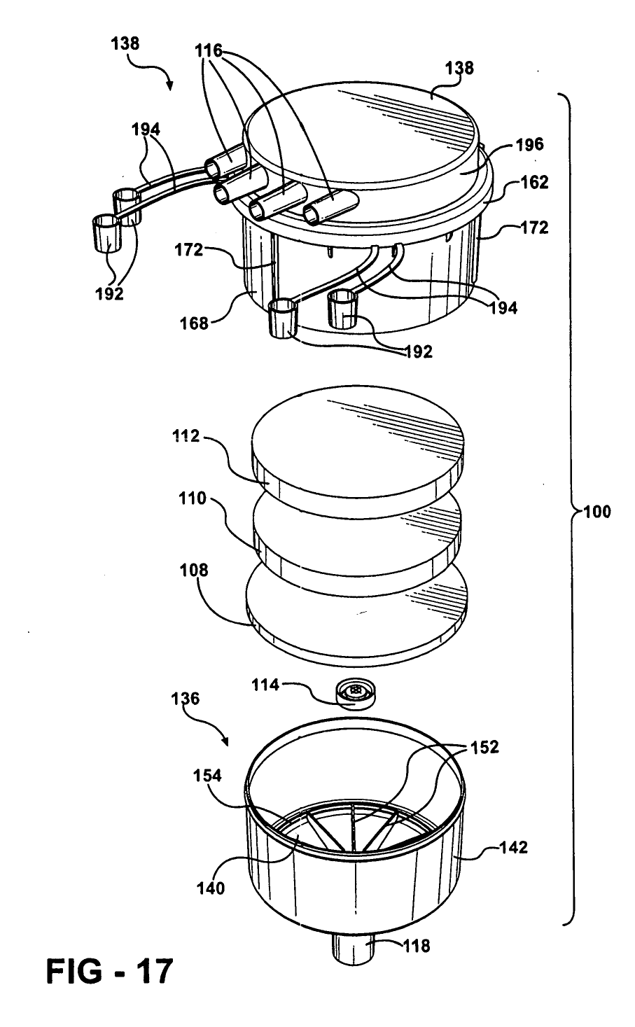

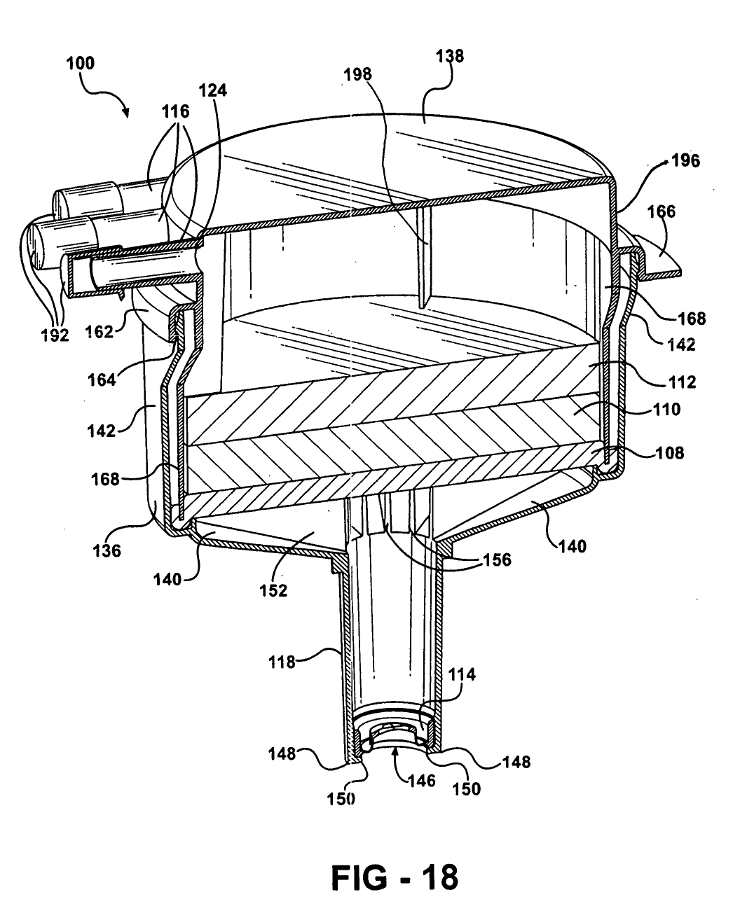

In a second embodiment of the invention, shown in FIGS. 16-18, the inlet check-valves 134 are eliminated. This allows the inlet ports 116 to extend laterally and away from a face wall 196 of the manifold top 138. The port caps 192 are used to cover the inlet ports 116 when the manifold assembly 100 is removed from the medical waste collection device 104, thereby containing the system. The embodiment is acceptable if the inlet ports 116 are located above the residual fluid volume level and sufficiently separate from each other such that cross-contamination between the inlet ports 116 is not an issue.

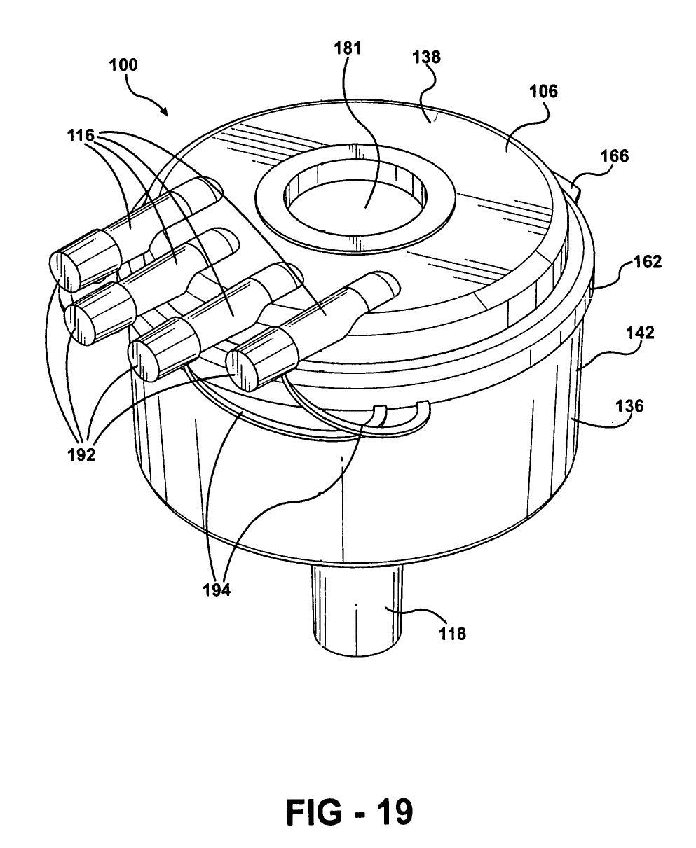

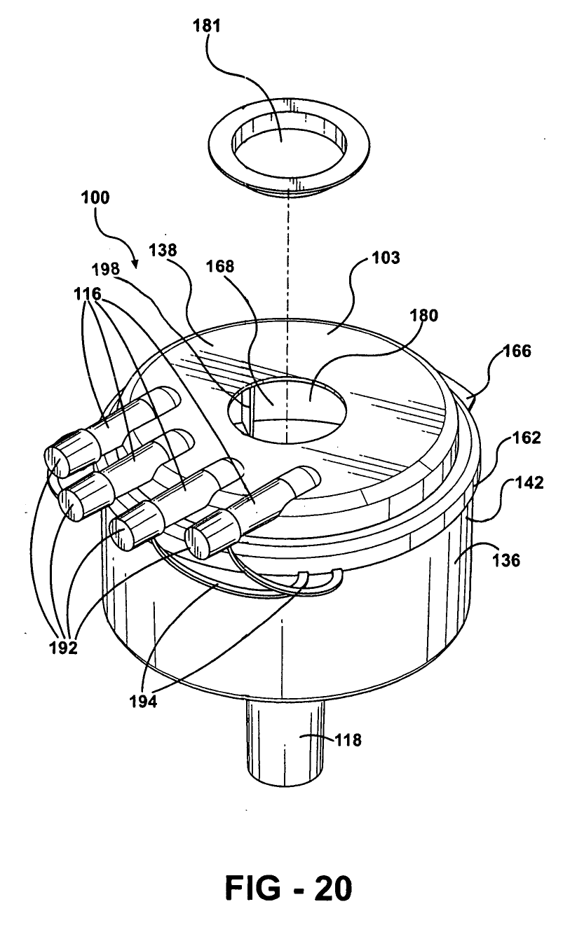

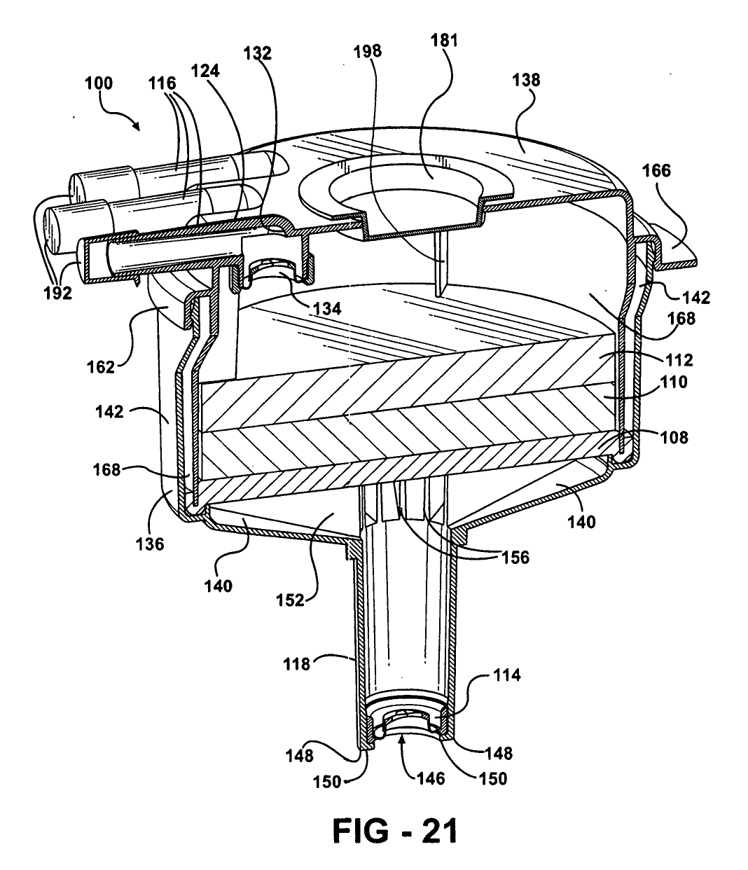

In a third embodiment of the invention, shown in FIGS. 19-21, the cover defines an access port 180 for collecting the material 102 from the filter 108, 110, 112 in the manifold housing 106. An access cover 181 closes the access port 180 and is removable for opening the access port 180 for the removal of material 102 from the filter 108, 110, 112 in the manifold housing 106 without having to remove the entire manifold top 138.

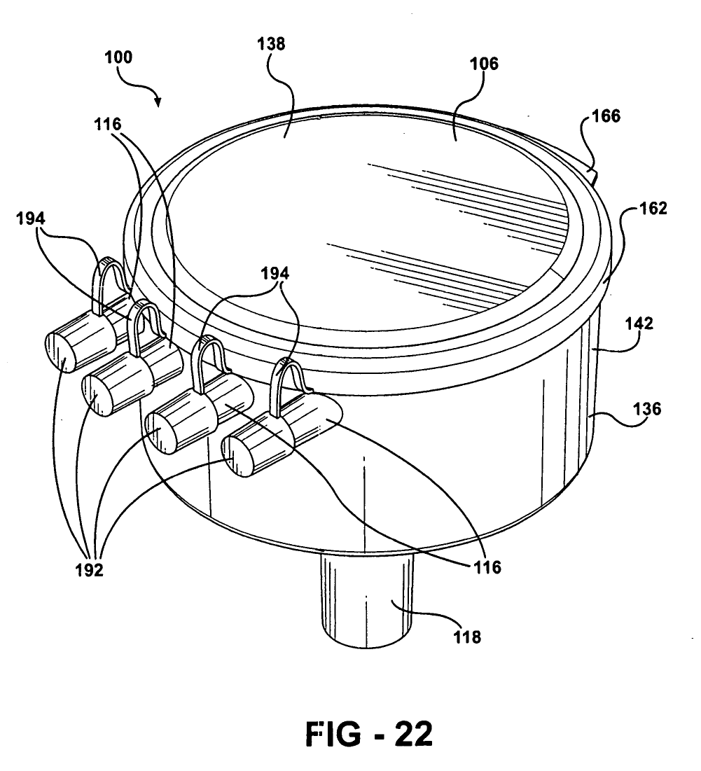

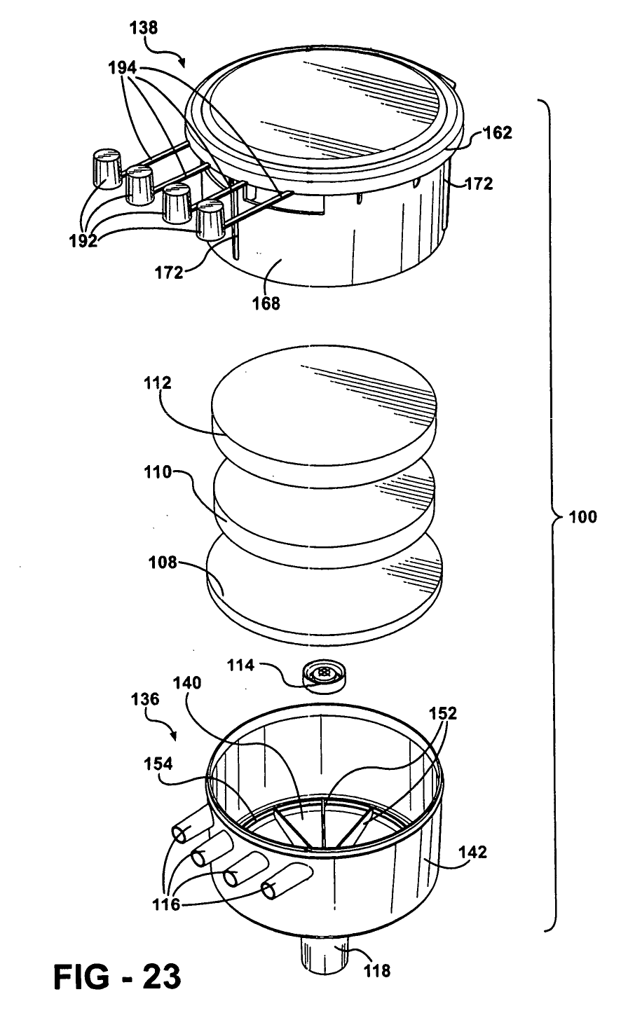

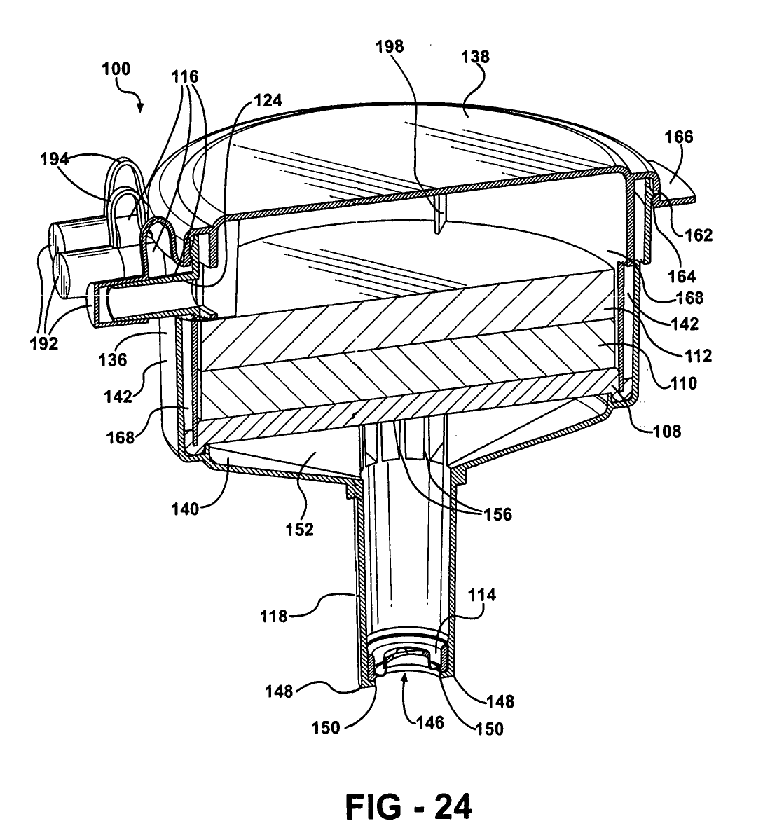

In a fourth embodiment of the invention, shown in FIGS. 22-24, the inlet ports 116 are disposed within the peripheral wall 142 of the manifold body 136 instead of being disposed within the manifold top 138. With this embodiment, the inlet check-valves 134 are not required. The port caps 192 may be used to cover the inlet ports 116 when the manifold assembly 100 is removed from the medical waste collection device 104. The port caps 192 are joined to either the manifold top 138 or the manifold body 136 via the connection straps 194. This embodiment is acceptable with the inlet check-valves 134 eliminated if the inlet ports 116 are located above the residual fluid volume level and sufficiently separate from each other such that cross-contamination is not an issue. By integrating the inlet ports 116 within the peripheral wall 142 of the manifold body 136, manufacturability is improved by reducing the number of parts in the manifold assembly 100.

Additionally, it is preferable that the manifold housing 106 is semi-transparent for viewing the material 102 in the manifold housing 106 and to determine if the manifold assembly 100 has already been used. This is important because the manifold assembly 100 is intended to be used only one time.

Obviously, many modifications and variations of the present invention are possible in light of the above teachings. In addition, the reference numerals in the claims are merely for convenience and are not to be read in any way as limiting.

1. A manifold assembly for directing and filtering material from fluid flowing into a medical waste collection device, said assembly comprising:
a manifold housing defining a plurality of inlet ports and at least one outlet port in spaced relationship to said inlet ports to establish a fluid path;
a primary filter disposed in said fluid path between said inlet ports and said outlet port to filter the material from the fluid in said fluid path; and
a plurality of port caps for covering said plurality of inlet ports and a plurality of connection straps integrally formed on said manifold housing connecting each of said port caps to said manifold housing for retaining each of said port caps to said manifold housing when not covering the associated inlet port.

2. A manifold assembly as set forth in claim 1 further comprising an outlet check-valve disposed at said outlet port for retaining the fluid in said housing.

3. A manifold assembly as set forth in claim 1 wherein said manifold housing defines an access port for collecting the material from said primary filter in said manifold housing.

4. A manifold assembly as set forth in claim 3 further including an access cover for closing said access port and removable for opening said access port.

5. A manifold assembly as set forth in claim 1 wherein said manifold housing is semi-transparent for viewing the material in the manifold housing.

6. A manifold assembly as set forth in claim 1 wherein each of said plurality of inlet ports includes an entrance tube disposed about an entry axis.

7. A manifold assembly as set forth in claim 6 wherein all of said entry axes are parallel.

8. A manifold assembly as set forth in claim 6 wherein all of said entry axes are non-parallel.

9. A manifold assembly as set forth in claim 6 wherein each of said inlet ports includes an exit tube disposed on an exit axis.

10. A manifold assembly as set forth in claim 9 wherein said exit axis is transverse to said entry axis.

11. A manifold assembly as set forth in claim 10 wherein each of said entrance tubes includes a directional wall normal to said inlet flow axis for turning the fluid from said entry axis and into said inlet exit tube along said exit axis.

12. A manifold assembly as set forth in claim 9 further including an inlet check-valve disposed at each of said inlet ports for opening in response to a predetermined vacuum pressure applied to the outlet port from the medical waste collection device.

13. A manifold assembly as set forth in claim 12 wherein each of said inlet check-valves is disposed about one of said exit tubes.

14. A manifold assembly as set forth in claim 6 wherein said manifold housing includes a manifold body having a bottom and a peripheral wall extending upwardly from said bottom, and a manifold top disposed over said peripheral wall to define a chamber.

15. A manifold assembly as set forth in claim 14 wherein said outlet port is disposed in said bottom of said manifold body and extends downwardly therefrom about an outlet axis to an outlet end.

16. A manifold assembly as set forth in claim 15 wherein said outlet port extends to a lower end and a retaining flange extends radially inward at said outlet end, said outlet check valve being disposed on said retaining flange within said outlet port on said outlet flow axis.

17. A manifold assembly as set forth in claim 15 wherein said outlet port is centrally disposed and said bottom is conical and slopes downwardly from said peripheral wall to said outlet port.

18. A manifold assembly as set forth in claim 17 wherein said manifold housing further includes a plurality of spaced support spokes extending radially from said outlet port.

19. A manifold assembly as set forth in claim 18 wherein said primary filter is supported by said support spokes.

20. A manifold assembly as set forth in claim 19 wherein said primary filter is comprised of a plurality of filter layers and supported by said support spokes to filter the material from the fluid in said fluid path.

21. A manifold assembly as set forth in claim 20 wherein at least two of said filter layers has a different porosity.

22. A manifold assembly as set forth in claim 18 wherein said body includes an outer rim disposed adjacent said peripheral wall and about and engaging said support spokes.

23. A manifold assembly as set forth in claim 22 wherein said outer rim is spaced from said peripheral wall to define a groove therebetween.

24. A manifold assembly as set forth in claim 23 wherein said manifold top includes a skirt defining a cylinder extending downwardly to a bottom edge disposed in said groove between said outer rim and said peripheral wall for engaging and compressing a perimeter of said primary filter into said groove.

25. A manifold assembly as set forth in claim 24 including a plurality of retainers disposed on and spaced about said skirt in said chamber wherein said filters are disposed above said support spokes and disposed below said retainers for retaining said filters on said support spokes

26. A manifold assembly as set forth in claim 14 wherein said inlet ports are disposed on one of said manifold body and said manifold top.

27. A manifold assembly as set forth in claim 14 wherein said manifold top includes a peripheral brim extending over and engaging the exterior of said peripheral wall.

28. A manifold assembly as set forth in claim 27 including a snap together lock interconnecting said brim and said peripheral wall to removably connect and retain said manifold top on said manifold housing.

29. A manifold assembly as set forth in claim 28 wherein said manifold top includes a skirt defining a cylinder extending downwardly to a bottom edge skirt in said chamber and a plurality of alignment ribs disposed on said skirt and engaging said peripheral wall of said manifold housing to center said manifold top with said manifold body.

30. A manifold assembly as set forth in claim 1 wherein said primary filter is comprised of a plurality of filter layers.

31. A manifold assembly as set forth in claim 30 wherein each of said filter layers has a different porosity.

32. A manifold assembly for directing and filtering material from fluid flowing into a medical waste collection device, said assembly comprising;
a manifold body having a bottom,
a peripheral wall extending upwardly from said bottom,
an outlet port centrally disposed on said bottom to define an outlet flow axis,
said bottom being conical and sloping downwardly from said peripheral wall to said outlet port,
a manifold top connected to said peripheral wall to define a chamber in said manifold body,
a plurality of inlet ports disposed on one of said manifold body and said manifold top,
each of said inlet ports including an entrance tube disposed about an entry axis,
exit tube disposed on an exit axis transverse to said entry axis,
each of said entrance tubes including a directional wall normal to said inlet flow axis for turning the fluid from said entry axis and into said inlet exit tube along said exit axis,
a filter supported above said bottom to filter the material from the fluid in said fluid path,
a plurality of port caps for covering said plurality of inlet ports,
a plurality of connection straps connecting each of said port caps to said manifold housing for retaining each of said port caps to said manifold housing when not covering the associated inlet port,
an inlet check-valve disposed in each of said exit tubes of said inlet ports, and
an outlet check valve disposed in said outlet port for opening in response to a predetermined vacuum pressure applied to said outlet port from the medical waste collection device.

33. A manifold assembly for directing and filtering material from fluid flowing into a medical waste collection device, said assembly comprising:
a manifold housing defining a plurality of inlet ports and at least one outlet port in spaced relationship to said inlet ports to establish a fluid path;
a primary filter disposed in said fluid path between said inlet ports and said outlet port to filter the material from the fluid in said fluid path; and
an outlet check-valve disposed at said outlet port for retaining the fluid in said housing.
